(19) United States
(12) Patent Application Publication
(10) Pub. No.: US 2026/0182588 A1
(43) Pub. Date: Jul. 2, 2026

(54) MEAT PROCESSING TOOL COMPRISING DISSOLVABLE HANDLE MATERIAL

(71) Applicant: Cargill, Incorporated, Wayzata, MN (US)

(72) Inventor: Tyson Brown, Godley, TX (US)

(73) Assignee: Cargill, Incorporated, Wayzata, MN (US)

(21) Appl. No.: 19/131,393

(22) PCT Filed: Nov. 8, 2023
(86) PCT No.: PCT/US2023/079125

§ 371 Date: May 20, 2025

Related U.S. Application Data
(60) Provisional application No. 63/384,672, filed on Nov. 22, 2022.

(51) Int. Cl. A22B 5/00; B25G 1/10

(52) U.S. Cl. CPC A22B 5/0047; B25G 1/102

(57) ABSTRACT

A meat processing tool comprises a metal tool component and a dissolvable polymeric component. The dissolvable polymeric component comprises a biologically compatible, dissolvable polymer that dissolves in aqueous media at a temperature of from 20° C. to 130° C. in 45 minutes or less when measured according to the Polymer Pellet Dissolution Test. The meat tool is used in a method of processing meat to remove contaminates sourced from meat processing tools where the meat is processed and meat portions are comminuted and heat-treated. A metal detection screening is conducted to identify and segregate any metal present in the heat-treated meat composition, and the resulting heat-treated meat composition is substantially free of particulate matter derived from the dissolvable polymeric component.

### CROSS-REFERENCE TO RELATED APPLICATIONS

This application claims the benefit of U.S. Provisional Application No. 63/384,672, filed Nov. 22, 2022, and entitled “MEAT PROCESSING TOOL COMPRISING DISSOLVABLE HANDLE MATERIAL,” which is incorporated by reference herein in its entirety.

### FIELD

The present invention relates to meat processing tools, such as knives, hooks and the like.

### BACKGROUND

During processing of meat, foreign objects such as pieces of metal, glass, plastic or the like may be inadvertently introduced that may cause harm to the consumer if ingested. Various approaches have been used to determine the presence/absence of a contaminant mixed in a food product, such as by using an X-ray transmission image (see, for example, U.S. Pat. No. 6,023,497) or a metal detection system image (see, for example, U.S. Pat. No. 8,278,918).

### SUMMARY

During commercial meat processing, animal carcasses are fabricated into smaller meat portions including primal, sub-primal, and trim portions. Meat trim, which generally include lesser value meat cuts, is commonly processed by comminuting (e.g, by grinding) the meat, for example, into ground meat for use in burgers and sausages, and the like. It has been discovered that tools may accidentally enter the comminuting step of the processing operation, for example, by slipping out of the hands of meat processing personnel during the fabrication process. While it is possible to detect metal that goes through the comminuting or grinding stage using available metal detection techniques, methods of detecting plastic components of a tool that has been comminuted or ground are not known. Therefore, when a tool containing a conventional plastic component passes through a comminuting or grinding operation, the only available way of dealing with the plastic contaminate involves disposing of large amounts of potentially contaminated product.

It is possible to fabricate tools completely out of metal for use in the meat processing industry that are relatively easy to detect by X-ray or other detection systems even after the tool has passed through a comminuting step or a grinder. However, all-metal tools are not ergonomically desirable, because they are cold, hard, and slippery when used in a wet environment. Likewise, it is possible to fabricate tools completely out of dissolvable plastic materials. However, all-plastic tools are limited in performance because they are not as durable as metal tools. For example, an all-plastic knife tool tends to lose its sharp edge quickly and is not easily resharpened. Likewise, an all-plastic hook may not have the strength required to perform meat handling operations without breaking.

In an aspect, a meat processing tool is provided that comprises a metal tool component and a dissolvable polymeric component, wherein the dissolvable polymeric component comprises a biologically compatible, dissolvable polymer that dissolves in aqueous media at a temperature of from 20° C. to 130° C. in 45 minutes or less when measured according to the Polymer Pellet Dissolution Test.

For purposes of the present discussion, a dissolvable polymeric component is a component that dissolves or is otherwise degraded or decomposed into a solution or a mixture that does not contain particulate matter in a form that would be problematic for livestock processing, i.e., the mixture does not contain particulate matter that would result in a feed safety claim under relevant USDA regulations due to particulate matter of a product resulting from meat processing.

For purposes of the present discussion, a biologically compatible, dissolvable polymer is a polymer that, when dissolved or broken down to any degradants or reactants produced from dissolving the biologically compatible, dissolvable polymer in water or aqueous media, is suitable for use in animal feed applications.

Advantageously, the dissolvable polymeric component comprises a biologically compatible, dissolvable polymer that dissolves in conditions associated with a heat-treating step in meat processing. This facilitates reduction or elimination of the risk of particulate contamination from dissolvable polymeric component in the heat-treated meat composition obtained in the meat processing step, without modification of the processing conditions conventionally carried out in a meat processing facility. Further, because the dissolvable polymer is biologically compatible, a separate polymer separation step is not required to provide a commercially valuable heat-treated meat composition.

In an aspect, the dissolvable polymeric component comprises a biologically compatible, dissolvable polymer selected from the group consisting of polyvinyl alcohol polymer, polylactic acid polymer, bloodmeal, and mixtures thereof.

Described herein are also methods for processing meat to remove contaminates sourced from meat processing tools. In an aspect, the method comprises processing meat using at least one meat processing tool as described herein to provide meat portions; comminuting the meat portions; heating the comminuted meat at a temperature of at least about 120° C. for at least about 15 minutes to provide a heat-treated meat composition; and conducting a metal detection screening to identify and segregate any metal present in the heat-treated meat composition; wherein the heat-treated meat composition is substantially free of particulate matter derived from the dissolvable polymeric component.

### BRIEF DESCRIPTION OF THE DRAWINGS

The accompanying drawings, which are incorporated in and constitute a part of this application, illustrate several aspects of the invention and together with a description of the embodiments serve to explain the principles of the invention. A brief description of the drawings is as follows:

FIG. 1 is a perspective view of an exemplary meat processing tool that is a knife.

FIG. 2 is a perspective view of an exemplary meat processing tool that is a meat hook.

FIG. 3 is a cross-section view of the handle of node hook of FIG. 2 taken along line 3-3.

FIG. 4 is a perspective view of an exemplary meat processing tool that is a node hook.

FIG. 5 is a cross-section view of handle 46 of node hook 400 of FIG. 4 taken along line 5-5.

### DETAILED DESCRIPTION

The aspects of the present invention described below are not intended to be exhaustive or to limit the invention to the precise forms disclosed in the following detailed description. Rather a purpose of the aspects chosen and described is by way of illustration or example, so that the appreciation and understanding by others skilled in the art of the general principles and practices of the present invention can be facilitated.

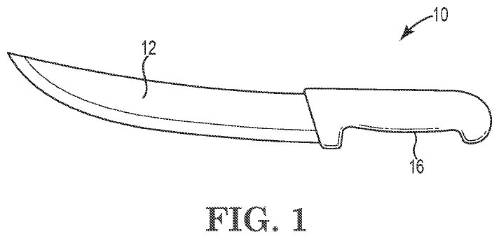

Turning now to the Figures, FIG. 1 is a perspective view of an exemplary meat processing tool that is knife 10. Knife 10 comprises metal tool component that is blade 12, and dissolvable polymeric component that is handle 14. In an aspect, the dissolvable polymeric component is an outer layer on an underlying metal substrate.

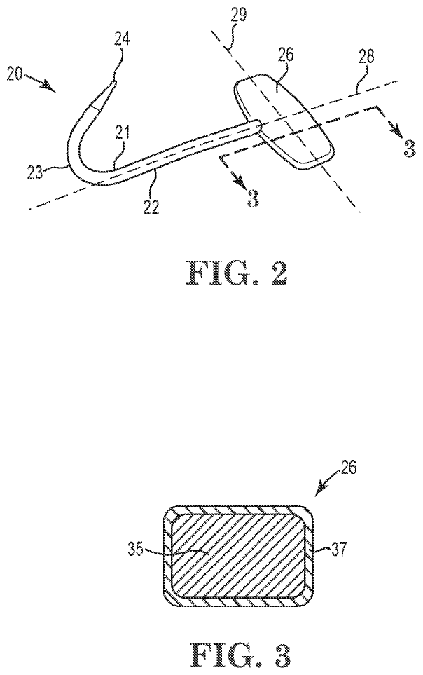

FIG. 2 is a perspective view of an exemplary meat processing tool that is meat hook 20. Meat hook 20 comprises a metal tool component that is hook 21, and dissolvable polymeric component that is handle 26. As shown, hook 21 comprises a generally straight portion 22 extending along longitudinal line 28 and a curved portion 23 curving away from straight portion 22 and terminating at point 24. Handle 26 is oriented to have a long dimension transverse to longitudinal line 28, i.e., extending along transverse line 29. The orientation of handle 26 assists in providing easy gripping of the tool and leverage by meat processing personnel to manipulate meat portions using meat hook 20. An example of a general design of a conventional meat hook that may be adapted to incorporate a dissolvable polymeric component as described herein is shown at U.S. Pat. No. 7,896,414.

FIG. 3 is a cross-section view of handle 26 of meat hook 20 of FIG. 2 taken along line 3-3. The dissolvable polymeric component 37 is provided as an outer layer on an underlying metal substrate 35. As shown, the underlying metal substrate 35 is a solid substrate. In an aspect, the underlying metal substrate may be provided as a hollow metal substrate.

In an aspect, the dissolvable polymeric component may be provided as an outer layer having a thickness of from 1 mm to 12 mm thick. In an aspect, the dissolvable polymeric component may be provided as an outer layer having a thickness of from 3 mm to 10 mm thick. In an aspect, the dissolvable polymeric component may be provided as an outer layer having a thickness of from 4 mm to 8 mm thick.

Providing the dissolvable polymeric component as a relatively thin outer layer on a metal substrate advantageously limits the thickness of the dissolvable polymeric component at any given location on the meat processing tool, thereby facilitating rapid dissolving of the dissolvable polymeric component in conditions associated with a heat-treating step in livestock processing. By providing the dissolvable polymeric component in configurations that have low bulk, the risk of residual, undissolved polymeric component being present after heat-treating is reduced even more, while not sacrificing the benefits of reduced slipperiness, hardness and coldness of the tool as perceived by users of the tool as compared to all-metal tools.

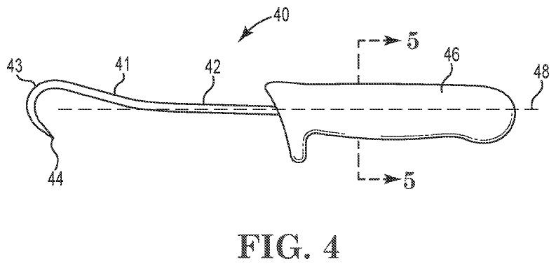

FIG. 4 is a perspective view of an exemplary meat processing tool that is node hook 40 (sometimes called a “pick hook” in the industry). Node hook 40 comprises a metal tool component that is hook 41, and dissolvable polymeric component that is handle 46. As shown, hook 42 comprises a generally straight portion 42 extending along longitudinal line 48 and a curved portion 43 curving away from straight portion 42 and terminating at point 44. Handle 46 is oriented to have a long dimension generally parallel to longitudinal line 28. The orientation of handle 46 assists in providing easy gripping of the tool for precise manipulation of meat portions by meat processing personnel using meat hook 40. An example of a general design of a conventional node hook that may be adapted to incorporate a dissolvable polymeric component as described herein is shown at U.S. Pat. No. 1,542,503.

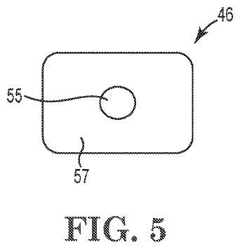

FIG. 5 is a cross-section view of handle 46 of node hook 400 of FIG. 4 taken along line 5-5. The dissolvable polymeric component 57 is provided as a bulk component that forms the handle that is formed around an underlying metal substrate 55. In an aspect, underlying metal substrate 55 is simply an extension of hook 41. Providing the dissolvable polymeric component as a bulk component that forms the handle is advantageous in reducing cost and simplifying production of the tool.

In an aspect, the dissolvable polymeric component comprises a biologically compatible, dissolvable polymer that is suitable for use in feed applications. By selection of biologically compatible ingredients, the dissolvable polymeric component dissolves and/or degrades when exposed to water or aqueous media and elevated temperature, such that components of meat processing tools that may inadvertently pass through the comminuting/grinding step of a meat processing operation can be either (1) safely removed (in the case of metal tool components), (2) effectively dissolved to harmless non-particulate matter or (3) present in the form of particulate matter that is considered inert or are otherwise suitable for feed products and feed processing.

In an aspect, the dissolvable polymeric component of the meat processing tool comprises biologically compatible, dissolvable polymer and optional additional ingredients such that any particles or pieces generated by passage of the meat processing tool through the comminuting step of a meat processing operation will be dissolved during a heat-treatment step of at least 15 minutes at 125° C., so that the resulting heat-treated composition does not contain particulate matter in a form that would result in a feed safety claim. In an aspect, the dissolvable polymeric component of the meat processing tool comprises biologically compatible, dissolvable polymer and optional additional ingredients such that any particles or pieces generated by passage of the meat processing tool through the comminuting step of a meat processing operation will be dissolved during a heat-treatment step of at least 15 minutes at 125° C., so that the resulting heat-treated meat composition is substantially free of particulate matter derived from the dissolvable polymer.

In an aspect, the dissolvable polymeric component dissolves in conditions associated with a heat-treating step in meat processing. In an aspect, the heat-treating step is a rendering step.

In an aspect, the dissolvable polymeric component can be completely dissolved in water or aqueous media within 45 minutes or less at 127° C. In an aspect, the dissolvable polymeric component can be completely dissolved in water or aqueous media within 45 minutes or less at 125-127° C. In an aspect, the dissolvable polymeric component can be completely dissolved in water within 45 minutes or less at 126-128° C. In an aspect, the dissolvable polymeric component can be completely dissolved in water or aqueous media within 30 minutes or less at 125-127° C. In an aspect, the dissolvable polymeric component can be completely dissolved in water or aqueous media within 15 minutes or less at 125-127° C. In an aspect, the dissolvable polymeric component can be completely dissolved in water or aqueous media within 45 minutes or less at 120-125° C.

In an aspect, the biologically compatible, dissolvable polymer can be completely dissolved in water or aqueous media in 10 minutes or less at 25° C. In an aspect, the biologically compatible, dissolvable polymer can be completely dissolved in water or aqueous media in 6 minutes or less at 25° C. In an aspect, the biologically compatible, dissolvable polymer can be completely dissolved in water or aqueous media in 3 minutes or less at 25° C. In an aspect, the biologically compatible, dissolvable polymer can be completely dissolved in water or aqueous media in 10 minutes or less at 24-26° C. In an aspect, the biologically compatible, dissolvable polymer can be completely dissolved in water or aqueous media in 10 minutes or less at 20-30° C. In an aspect, the biologically compatible, dissolvable polymer can be completely dissolved in water or aqueous media in 10 minutes or less at 150° C. In an aspect, the biologically compatible, dissolvable polymer can be completely dissolved in water or aqueous media in 1 minute or less at 150° C. In an aspect, the biologically compatible, dissolvable polymer can be completely dissolved in water or aqueous media in 10 minutes or less at 20 to 130° C.

In an aspect, each of the dissolution conditions discussed above refer to a dissolvable polymeric component having a maximum thickness of approximately 1 cm in thickness, i.e., no portion of the dissolvable polymeric component is significantly thicker than 1 cm. In an aspect, each of the dissolution conditions discussed above refer to a dissolvable polymeric component having a maximum thickness of approximately 4 mm, i.e., no portion of the dissolvable polymeric component is significantly thicker than 4 mm. In an aspect, each of the dissolution conditions discussed above refer to a dissolvable polymeric component having a mass of 10 grams or less. In an aspect, each of the dissolution conditions discussed above refer to a dissolvable polymeric component having a mass of 1 to 10 grams. In an aspect, each of the dissolution conditions discussed above refer to a dissolvable polymeric component having a mass of about 5 grams. In an aspect, each of the dissolution conditions discussed above refer to a dissolvable polymeric component having a mass of 4.5 to 5.5 grams.

In an aspect, the biologically compatible, dissolvable polymer dissolves at a rate of 5 g/min or less; 4 g/min or less; 3 g/min or less; 2 g/min or less; 1 g/min or less; 0.9 g/min or less; 0.8 g/min or less; 0.7 g/min or less; 0.6 g/min or less; 0.5 g/min or less; 0.4 g/min or less; 0.3 g/min or less; 0.2 g/min or less; or 0.1 g/min or less. The rate of dissolution of the biologically compatible, dissolvable polymer can be measured using the same conditions (e.g., pellet type, buffer, temperature, and timing) as the Polymer Pellet Dissolution Test (defined below).

For the purposes of the present disclosure, the dissolution conditions of the biologically compatible, dissolvable polymer is evaluated as follows, referred to herein as the “Polymer Pellet Dissolution Test”: 1) pellets consisting of the polymer composition are obtained, wherein each pellet is substantially cylindrical in shape and has a diameter of 2 to 2.5 mm and a length of about 3 mm; 2) weigh about 0.2 g of the pellets and record exact weight; load pellets into a G30 30 mL glass vial with a micro stir bar and 20 mL of 0.1 M pH 5 acetate buffer; 3) seal the vial with airtight septum; load the vial into an Anton Paar Monowave 300 microwave reactor and set program to “heat as fast as possible” to 127° C. (heating time not more than 2 min), hold at 127° C. for 45 min while stirring at 900 rpm, then set program to “cool as fast as possible” to 70° C. using forced air; 4) removing vial and decanting or filtering aqueous solution from vial; and 5) recording visual observation of evidence of residual pellet material and weighing any residual pellet material after drying.

It is to be understood that the dissolvable component of the devices can be completely dissolved in aqueous media at the same time and temperature ranges as disclosed for dissolution in water provided in this disclosure. In an aspect, the aqueous media can be a brine solution or a buffer solution. In an aspect, the aqueous media is an acetate buffer solution. In an aspect, the aqueous media is a phosphate buffer solution. In an aspect, the aqueous media has a pH of 5, a pH of 4.8 to 5.2, a pH of 4.5 to 4.4, a pH of 5 to 7, or a pH of 6 to 7. In an aspect, the aqueous media comprises lactic acid and/or peracetic acid. In an aspect, the aqueous media comprises blood, viscera, bone, and/or lungs from a slaughtered animal. In an aspect, the aqueous media comprises, protein, peptides, lipids, and/or carbohydrates.

In an aspect, the biologically compatible, dissolvable polymer comprises polyvinyl alcohol (PVA; polyvinyl alcohol may also be referred to as PVOH herein). In an aspect, the biologically compatible, dissolvable polymer comprises a partially hydrolyzed Polyvinyl acetate (PVAc) composition.

In an aspect, the dissolvable polymeric component may contain processing aids or other materials, such as plasticizers and strength modifiers (e.g., clay), that may not completely dissolve during livestock processing (e.g., due to insolubility in water of clay), but that nonetheless are degraded, decomposed, and/or partially dissolved in a manner that yields a post-processing product that does not contain particulate matter that would result in a feed safety claim of that product. In an aspect, such processing aids or other materials are considered inert or are otherwise suitable for feed products and feed processing. In an aspect, the post-processing product is free of particulate matter, i.e., no particulate matter can be detected using analysis techniques as required in the jurisdiction of inspection. In an aspect, the post-processing product is free of particulate matter derived from the dissolvable polymeric component, i.e., no particulate matter derived from the dissolvable polymeric component can be detected. In an aspect, the post-processing product is substantially free of particulate matter, but any particulate matter detected would not result in a feed safety claim.

Although the dissolvable component of the meat processing tools described herein are readily dissolvable in water or aqueous media at relatively mild conditions, the meat processing tools must also have the structural integrity needed for the targeted application, and must maintain that structural integrity prior to the heat-treating processing step in which the dissolvable component of the meat processing tools is dissolved.

In an aspect, the dissolvable component of the meat processing tools has a tensile strength of at least at least 1.0 MPa (Megapascal); at least 1.5 MPa; at least 2 MPa; at least 3 MPa; at least 4 MPa; at least 5 MPa; at least 6 MPa; at least 7 MPa; at least 8 MPa; at least 9 MPa; at least 10 MPa; at least 12 MPa; at least 15 MPa; at least 20 MPa; at least 25 MPa at least 30 MPa; at least 35 MPa; or at least 40 MPa.

In an aspect, the dissolvable component of the meat processing tools has a glass transition temperature (Tg) of greater than or equal to 35° C., 40° C., 45° C., 50° C., 55° C., 60° C., 65° C., 70° C., 75° C., 80° C., or 85° C.

The devices described herein may comprise PVA. PVA is generally produced by hydrolysis of polyvinyl acetate (PVAc), and can be produced having various degrees of hydrolysis. PVAc, i.e., fully acetylated PVA, is insoluble in water. The solubility of PVA in water generally increases with the degree of hydrolysis. As the acetate group content decreases with a corresponding increase of hydroxyl group content, the solubility of PVA increases. However, when the degree of hydrolysis approaches 100%, or is 100%, the solubility begins to decrease due to effects from intramolecular hydrogen bonding.

However, while the dissolvable polymeric component for the devices described herein must be readily dissolvable in water at a relatively low temperature, the devices must also maintain the structural integrity needed for the targeted application. In some cases, the devices may be exposed to water or moisture during livestock processing prior to the desired point of dissolution. Accordingly, in an aspect, the PVA may be partially hydrolyzed such that a device made from the PVA has the desired balance between dissolution rate and structural integrity.

In an aspect, the biologically compatible, dissolvable polymer comprises PVA having a degree of hydrolysis of 0.01 to 99.99 mol %; 0.1 to 99.9 mol %; 0.1 to 99 mol %; 1 to 99 mol %; 0.1 to 98 mol %; 1 to 98 mol %; 0.1 to 97 mol %; 1 to 97 mol %; 0.1 to 96 mol %; 1 to 96 mol %; 0.1 to 95 mol %; 1 to 95 mol %; 1 to 90 mol %; 1 to 85 mol %; 1 to 80 mol %; 50 to 100 mol %; 50 to 99 mol %; 50 to 97 mol %; 50 to 95 mol %; 50 to 90 mol %; 50 to 85 mol %; 50 to 80 mol %; 60 to 100 mol %; 60 to 95 mol %; 60 to 90 mol %; 60 to 85 mol %; 60 to 80 mol %; 70 to 99 mol %; 70 to 97 mol %; 70 to 95 mol %; 70 to 90 mol %; 70 to 85 mol %; 70 to 80 mol %; 75 to 100 mol %; 75 to 99 mol %; 75 to 95 mol %; 75 to 90 mol %; 75 to 85 mol %; 80 to 99 mol %; 80 to 95 mol %; 80 to 90 mol %. In an aspect, the biologically compatible, dissolvable polymer consists of PVA having a degree of hydrolysis of 0.01 to 99.99 mol %; 0.1 to 99.9 mol %; 0.1 to 99 mol %; 1 to 99 mol %; 0.1 to 98 mol %; 1 to 98 mol %; 0.1 to 97 mol %; 1 to 97 mol %; 0.1 to 96 mol %; 1 to 96 mol %; 0.1 to 95 mol %; 1 to 95 mol %; 1 to 90 mol %; 1 to 85 mol %; 1 to 80 mol %; 50 to 100 mol %; 50 to 99 mol %; 50 to 97 mol %; 50 to 95 mol %; 50 to 90 mol %; 50 to 85 mol %; 50 to 80 mol %; 60 to 100 mol %; 60 to 95 mol %; 60 to 90 mol %; 60 to 85 mol %; 60 to 80 mol %; 70 to 99 mol %; 70 to 97 mol %; 70 to 95 mol %; 70 to 90 mol %; 70 to 85 mol %; 70 to 80 mol %; 75 to 100 mol %; 75 to 99 mol %; 75 to 95 mol %; 75 to 90 mol %; 75 to 85 mol %; 80 to 99 mol %; 80 to 95 mol %; 80 to 90 mol %. In an aspect, the biologically compatible, dissolvable polymer consists essentially of PVA having a degree of hydrolysis of 0.01 to 99.99 mol %; 0.1 to 99.9 mol %; 0.1 to 99 mol %; 1 to 99 mol %; 0.1 to 98 mol %; 1 to 98 mol %; 0.1 to 97 mol %; 1 to 97 mol %; 0.1 to 96 mol %; 1 to 96 mol %; 0.1 to 95 mol %; 1 to 95 mol %; 1 to 90 mol %; 1 to 85 mol %; 1 to 80 mol %; 50 to 99 mol %; 50 to 97 mol %; 50 to 95 mol %; 50 to 90 mol %; 50 to 85 mol %; 50 to 80 mol %; 70 to 99 mol %; 70 to 97 mol %; 70 to 95 mol %; 70 to 90 mol %; 70 to 85 mol %; 70 to 80 mol %; 75 to 95 mol %; 75 to 90 mol %; 75 to 85 mol %; 80 to 99 mol %; 80 to 95 mol %; 80 to 90 mol %.

In an aspect, the biologically compatible, dissolvable polymer comprises PVA having a number average molecular weight (Mn) of 100 kDa or less; 90 kDa or less; 80 kDa or less; 70 kDa or less; 60 kDa or less; 50 kDa or less; 40 kDa or less; 30 kDa or less; 10 to 100 kDa; 20 to 80 kDa; 20 to 60 kDa; 30 to 60 kDa; 20 to 50 kDa; or 30 to 50 kDa. In an aspect, the biologically compatible, dissolvable polymer consists of PVA having a number average molecular weight (Mn) of 100 kDa or less; 90 kDa or less; 80 kDa or less; 70 kDa or less; 60 kDa or less; 50 kDa or less; 40 kDa or less; 30 kDa or less; 10 to 100 kDa; 20 to 80 kDa; 20 to 60 kDa; 30 to 60 kDa; 20 to 50 kDa; or 30 to 50 kDa.

In an aspect, the biologically compatible, dissolvable polymer can be a copolymer of PVA and one or more second polymers. Accordingly, throughout this disclosure, the word “PVA” shall also be construed to include “copolymer(s) of PVA with one or more second polymers.” The copolymers can be prepared in at least two ways. One method is to prepare the PVA and one or more second polymer(s) independently of each other, and then blend the PVA and one or more second polymers in varying ratios using methods known to those skilled in the art, such as by extrusion. A second method is to copolymerize the monomer for making PVA and the monomer(s) for making the one or more second polymer(s) in a polymerization reaction at the same time.

The monomer(s) for making the second polymer(s), i.e., the “second polymer monomer(s)” may have carboxylate or sulfonate functionality or esters of those two functional groups. Similar to the manufacture of PVA, the esters may be partially or fully hydrolyzed after polymerization. Examples of polymers containing such carboxylate functional groups are polyacrylic acid, polymethacrylic acid, polycrotonic acid, polyitaconic acid, polymaleic acid, and polyfumaric acid. The corresponding monomers that can be copolymerized with PVA monomers are acrylic acid, methacrylic acid, crotonic acid, itaconic acid, maleic acid, and fumaric acid.

Sulfonic acid-containing second polymer monomers include vinyl sulfonic acid, allyl sulfonic acid, ethylene sulfonic acid, 2-acrylamido-1-methylpropanesulfonic acid, 2-acrylamido-2-methylpropanesulfonic acid, 2-methylacrylamido-2-methylpropanesulfonic acid, and 2-sulfoethyl acrylate.

Other suitable second polymers include but are not limited to polyethyleneimines, polyvinyl pyrrolidones, pullulans, guar gums, xanthan gum, carrageenans, starches, ethoxylated starches, hydroxyethylated starches, hydroxypropylated starches, carboxymethylated starches, polyalkylene oxides, polyacrylamides, celluloses, cellulose ethers, cellulose esters, cellulosic amides, polyamino acids, polyamides, gelatins, methyl celluloses, carboxymethylated celluloses, maltodextrins.

The molar ratios of the monomer(s) in the resulting copolymers can be any ratio, such as from 1:99 to 99:1, so as to provide the desired properties for use in the present application. In an aspect, the molar ratio is 1-20 mole % of the second polymer monomer(s) relative to PVA.

The PVA compositions described herein are suitable for use in food applications and generally non-toxic at the levels expected when using these PVA compositions in livestock processing applications such as a heat-treating step, see e.g., Kawai and Hu, Biochemistry of microbial polyvinyl alcohol degradation, Appl. Microbiol. Biotechnol. 2009, 84(2): 227-37, which is hereby incorporated by reference in its entirety.

Meat processing tools made from the PVA compositions described herein can be produced using polymer manufacturing techniques presently known in the art, for example but not limited to: extrusion, injection molding, and/or 3D printing.

In an aspect, the biologically compatible, dissolvable polymer comprises polylactic acid (PLA). Polylactic acid polymer (or “PLA”) is derived from a sugar source such as corn, cellulosic raw materials, agricultural wastes and non-food plants. PLA polymers are described, for example, in U.S. Pat. No. 5,053,485 for use in the medical industry, the disclosure of which is incorporated herein by reference. PLA polymers such as described therein may be adapted as necessary by incorporation of alternative ingredients (such as monomers described therein) to shorten degradation time to meet the dissolving time and temperature characteristics as described herein.

In an aspect, the biologically compatible, dissolvable polymer comprises bloodmeal sourced plastics, such as described in U.S. Pat. No. 8,277,553 and WO 2013/081479. Bloodmeal sourced plastics are commercially available from Novotein Thermoplastic and Aduro Biopolymers.

Plasticizers can be included in the dissolvable polymeric component to reduce the brittleness and improve flexibility of the meat processing tool. Such plasticizers include, but are not limited to, water, glycerol, glycols, glycol ethers, natural oils, fatty acid esters, epoxidized natural oils, citric acid esters, esters of various organic monocarboxylic acids and polycarboxylic acids, sorbitol, sugar esters, Starch derivatives, and Cellulose derivatives.

The tensile strength of the dissolvable polymeric component can be improved by the use of additives, such as talc, silica, clays, starch, cellulose, keratin, chitin, chitosan, polylactic acid, polyhydroxyalkanoates, and inorganic compounds such as calcium carbonate.

The meat processing tools described herein can be used to prevent contamination of heat-treated meat composition produced from a slaughtered animal. The meat processing tools described herein described herein can be used for the processing of livestock such as cattle, bison, pigs, sheep and poultry.

In an aspect, the methods include processing meat using at least one meat processing tool as described herein to provide meat portions,
comminuting the meat portions to provide comminuted meat;
heat-treating the comminuted meat at a temperature of at least 15 minutes at 125° C. to provide a heat-treated meat composition; and
conducting a metal detection screening to identify and segregate any metal present in the heat-treated meat composition;
wherein the heat-treated meat composition is substantially free of particulate matter derived from the dissolvable polymer.

In an aspect, in the method the meat portions are comminuted to provide comminuted meat having particles ranging in size from about 2 mm to 20 mm; or wherein the meat portions are comminuted to provide comminuted meat having particles ranging in size from about 3 mm to 15 mm; or wherein the meat portions are comminuted to provide comminuted meat having particles ranging in size from about 3 mm to 10 mm; or wherein the meat portions are comminuted by grinding. In an aspect, the meat portions are comminuted by grinding to a course grind. In an aspect, the meat portions are comminuted by grinding to a fine grind.

In an aspect, the heat-treating step in the method is performed at a temperature of at least 127° C. for a time of at least 45 min.

### EXAMPLES

The invention is further described in detail by reference to the following experimental examples. These examples are provided for purposes of illustration only, and are not intended to be limiting unless otherwise specified. Thus, the invention should in no way be construed as being limited to the following examples, but rather should be construed to encompass any and all variations which become evident as a result of the teaching provided herein.

### Example 1: Evaluation of Polyvinyl Alcohol (PVA)

This example describes benchtop screening of PVA for use in dissolvable or degradable meat processing tools.

PVA samples were obtained commercially from Kuraray America, Inc. in various grades. Each sample was obtained as cylindrical pellets of about 2 to 2.5 mm diameter and about 3 mm length (example mass and dimensions of cylindrical pellets are listed in Table 1). Table 2 shows how fast each PVA sample dissolved in water at 25° C. or 80° C. Note that the tests in Table 2 were performed and published by Kuraray Europe GmbH and were done with 200 micron thick films at the reported temperatures.

TABLE 1

| PVA grade | Mass (mg) | Avg. Length (mm) | Avg. Diameter (mm) |
|---|---|---|---|
| H 15 | 15-16 | 3.1 | 2.2 |
| C 600 | 15-20 | 2.9 | 2.4 |
| M 05 | 16-17 | 3.1 | 2.5 |
| C 17 | 11-13 | 3.0 | 2.1 |

TABLE 2

| | | | | Max. moisture |
|---|---|---|---|---|
| | | Glass | | uptake (%) |
| | Solubility | Transition | Peak melting | (avg. at 23° C. |
| PVA | (temp and time to | Temp., | temp., Tm | and 50% relative |
| grade | dissolve) | Tg(° C.) | (° C.) | humidity) |
| C 17 | 25° C./3-6 min | 60 | 170 | 4 |
| C 30 | 25° C./3-6 min | 40 | 175 | 7 |
| C 600 | 25° C./<3 min | 35 | 165 | 7 |
| C 130T | 25° C./3-6 min | 45 | 170 | 4 |
| C 500T | 25° C./<3 min | 40 | 165 | 5 |
| M 05 | 55° C./>6 min | 45 | 195 | 6 |
| H 15 | 80° C./>6 min | 40 | 215 | 5 |

Table 2 note:
Tg and Tm provided from 2^{nd} heating cycle of DSC measurement at a heating rate of 10 K/min.

Dissolution reactions were completed in an Anton Paar Monowave 300 microwave reactor. About 0.2 g of polymer pellets were weighed, exact mass was recorded, then pellets were loaded into a G30 30 mL glass vial with a micro stir bar, 20 mL of 0.1 M pH 5 acetate buffer in DI water were added, and the vial was sealed with an air tight septum. Reactor program was set to “heat as fast as possible” to 127° C. (taking about 1 minute), hold for 45 minutes while stirring at 900 rpm, then “cool as fast as possible” to 70° C. with forced air (taking about 7 minutes). Table 3 shows the reaction conditions for each sample.

TABLE 3
PVA reaction conditions

| Reaction | | | | |
|---|---|---|---|---|
| # | 1 | 2 | 3 | 4 |
| sample | Mowiflex LP | Poval H15 | Poval C17 | Mowiflex M05 |
| | C600 | polyvinyl | polyvinyl | polyvinyl |
| | polyvinyl | alcohol | alcohol | alcohol |
| | alcohol | (Kuraray) | (Kuraray) | (Kuraray) |
| | (Kuraray) | | | |
| time | 45 | 45 | 45 | 45 |
| (min) | | | | |
| temp ° C. | 127 | 127 | 127 | 127 |
| solvent | pH 5 0.1M | pH 5 0.1M | pH 5 0.1M | pH 5 0.1M |
| | acetate | acetate | acetate | acetate |
| solvent | 20 | 20 | 20 | 20 |
| mL | | | | |
| polymer | 0.2103 | 0.2107 | 0.1984 | 0.2079 |
| g | | | | |

C600 was completely dissolved after 45 minutes at 127° C. No pellets or evidence of residual polymer was apparent.
H15 showed minor dissolution-or melting-forming a smooth disc on the bottom of the vial. The aqueous solution also turned hazy likely from partially soluble/dispersed polymers.
C17 mostly dissolved, bit not completely. A thick slurry of polymer rich phase was apparent on the bottom of the vial, which hardened onto air bubbles when inverted and cooled. The pellets began to stick to each other in solution before the heating reaction.
M05 was completely dissolved after 45 minutes at 127° C. No pellets or evidence of residual polymer was apparent.
Conclusion: Polyvinyl alcohol dissolution after 45 min at 127° C. at pH 5 depended on the particular PVA product grade. Mowiflex LP C 600 and Mowiflex M05 polyvinyl alcohol products showed the most complete dissolution, and were confirmed to have both acetate and —OH groups.

### Example 2: Evaluation of Polylactic acid (PLA)

This example describes benchtop screening of PLA for use in dissolvable or degradable meat processing tools.

Polylactic acid (PLA) pellets were obtained from NatureWorks. Three product codes were tested: 2003D, 4060D, and 6302D.

Dissolution reactions were completed in an Anton Paar Monowave 300 microwave reactor. About 0.2 g polymer pellets were weighed, exact mass was recorded, then pellets were loaded into a G30 30 mL glass vial with a micro stir bar, 20 mL of 0.1 M pH 5 acetate buffer in DI water were added, and the vial was sealed with an air tight septum. Reactor program was set to “heat as fast as possible” to 127° C. (taking about 1 minute), hold for 45 minutes while stirring at 900 rpm, then “cool as fast as possible” to 70 C with forced air (taking about 7 minutes). After decanting off the solution, residual polymer pellets were collected in a pre-weighed aluminum tin, and the polymer pellets were dried for at least 2 hours or until mass was constant in an Unox MindMap combi oven set at 45° C. and maximum moisture removal and constant fan at low.

Results are shown in Table 4. All PLA samples remained undissolved. Recoveries of slightly greater than 100% were likely due to residual sodium acetate. Pellets of biopolymers 4060D and 6302D melted together into one aggregated mass, while biopolymer 2003D remained as individual pellets.

TABLE 4
PLA dissolution reactions

| sample | 4060D | 6302D | 2003D |
|---|---|---|---|
| time (min) | 45 | 45 | 45 |
| temp ° C. | 127 | 127 | 127 |
| solvent | pH 5 0.1M | pH 5 0.1M | pH 5 0.1M |
| | acetate | acetate | acetate |
| solvent (mL) | 20 | 20 | 20 |
| polymer initial | 0.2013 | 0.2062 | 0.2018 |
| (g) | | | |
| polymer final (g) | 0.2036 | 0.2052 | 0.2051 |
| % recovered | 101.1 | 99.5 | 101.6 |

Conclusion: Polylactic acid samples tested were not dissolved after 45 min at 127° C. at pH 5, demonstrating that not all polymers are structurally suitable for livestock processing devices also have the desired dissolution characteristics for such applications.

As used herein, the terms “about” or “approximately” mean within an acceptable range for the particular parameter specified as determined by one of ordinary skill in the art, which will depend in part on how the value is measured or determined, e.g., the limitations of the sample preparation and measurement system. Examples of such limitations include preparing the sample in a wet versus a dry environment, different instruments, variations in sample height, and differing requirements in signal-to-noise ratios. For example, “about” can mean greater or lesser than the value or range of values stated by 1/10 of the stated values, but is not intended to limit any value or range of values to only this broader definition. For instance, a concentration value of about 30% means a concentration between 27% and 33%. Each value or range of values preceded by the term “about” is also intended to encompass the embodiment of the stated absolute value or range of values. Alternatively, particularly with respect to biological systems or processes, the term can mean within an order of magnitude, preferably within 5-fold, and more preferably within 2-fold, of a value.

Throughout this specification and claims, unless the context requires otherwise, the word “comprise”, and variations such as “comprises” and “comprising”, will be understood to imply the inclusion of a stated integer or step or group of integers or steps but not the exclusion of any other integer or step or group of integer or step. When used herein “consisting of” excludes any element, step, or ingredient not specified in the claim element. When used herein, “consisting essentially of” does not exclude materials or steps that do not materially affect the basic and novel characteristics of the claim. In the present disclosure of various embodiments, any of the terms “comprising”, “consisting essentially of” and “consisting of” used in the description of an embodiment may be replaced with either of the other two terms.

All patents, patent applications (including provisional applications), and publications cited herein are incorporated by reference as if individually incorporated for all purposes. Unless otherwise indicated, all parts and percentages are by weight and all molecular weights are weight average molecular weights. The foregoing detailed description has been given for clarity of understanding only. No unnecessary limitations are to be understood therefrom. The invention is not limited to the exact details shown and described, for variations obvious to one skilled in the art will be included within the invention defined by the claims.

1. A meat processing tool, comprising:
a metal tool component and a dissolvable polymeric component,
wherein the dissolvable polymeric component comprises a biologically compatible, dissolvable polymer that dissolves in aqueous media at a temperature of from 20° C. to 130° C. in 45 minutes or less when measured according to the Polymer Pellet Dissolution Test.

2. The meat processing tool of claim 1, wherein the tool is selected from the group consisting of a knife, a meat hook, and a node hook.

3. The meat processing tool of claim 1, wherein the dissolvable polymeric component is a handle.

4. The meat processing tool of claim 1, wherein the dissolvable polymeric component is an outer layer on an underlying metal substrate.

5. The meat processing tool of claim 4, wherein the dissolvable polymeric component outer layer has a thickness of from 1 mm to 12 mm thick.

6. The meat processing tool of claim 1, wherein the dissolvable polymeric component is a component that dissolves or is otherwise degraded or decomposed into a composition after exposure to an aqueous heat treatment of at least 15 minutes at 125° C., wherein the heat-treated composition does not contain particulate matter in a form that would result in a feed safety claim.

7. The meat processing tool of claim 1, wherein the dissolvable polymeric component comprises a biologically compatible, dissolvable polymer selected from the group consisting of polyvinyl alcohol polymer, polylactic acid polymer, bloodmeal, and mixtures thereof.

8. The meat processing tool of claim 1, wherein the dissolvable polymeric component further comprises one or more additives selected from the group consisting of: talc, silica, clays, starch, cellulose, keratin, chitin, chitosan, polylactic acid, polyhydroxyalkanoates, and calcium carbonate.

9. The meat processing tool of claim 1, wherein the dissolvable polymeric component further comprises one or more plasticizers.

10. The meat processing tool of claim 1, wherein the biologically compatible, dissolvable polymer dissolves in water or aqueous media.

11. The meat processing tool of claim 1, wherein the dissolvable polymeric component dissolves in water or aqueous media at a temperature of 127° C. in 45 minutes or less.

12. The meat processing tool of claim 1, wherein the biologically compatible, dissolvable polymer is PVA, and wherein the PVA has a degree of hydrolysis of 50-100 mol %.

13. The meat processing tool of claim 1, wherein the biologically compatible, dissolvable polymer is a PVA copolymer of PVA and one or more second polymers.

14. The meat processing tool of claim 13, wherein the one or more second polymers in the PVA copolymer is formed from one or more of the following monomers: acrylic acid, methacrylic acid, crotonic acid, itaconic acid, maleic acid, fumaric acid, vinyl sulfonic acid, allyl sulfonic acid, ethylene sulfonic acid, 2-acrylamido-1-methylpropanesulfonic acid, 2-acrylamido-2-methylpropanesulfonic acid, 2-methylacrylamido-2-methylpropanesulfonic acid, or 2-sulfoethyl acrylate.

15. The meat processing tool of claim 1, wherein the biologically compatible, dissolvable polymer is a copolymer of PVA and one or more of: a polyethyleneimine, a polyvinyl pyrrolidone, a pullulan, a guar gum, a xanthan gum, a carrageenan, a starch, a ethoxylated starch, a hydroxyethylated starch, a hydroxypropylated starch, a carboxymethylated starch, a polyalkylene oxide, a polyacrylamide, a cellulose, a cellulose ether, a cellulose ester, a cellulosic amide, a polyamino acid, a polyamide, a gelatin, a methylcellulose, a carboxymethylated cellulose, or a maltodextrin.

16. The meat processing tool of claim 13, wherein the molar percent ratio of the total amount of second polymer(s) in the PVA copolymer is 1-20% of second polymer(s) relative to PVA.

17. The meat processing tool of claim 1, wherein the biologically compatible, dissolvable polymer is PVA, and wherein the PVA has a tensile strength of at least 1 MPa.

18. The meat processing tool of claim 1, wherein the biologically compatible, dissolvable polymer is PVA, and wherein the PVA has a glass transition temperature of 35° C.

19. The meat processing tool of claim 1, wherein the biologically compatible, dissolvable polymer is PVA, and wherein the PVA has a number average molecular weight (Mn) of 100 kDa or less.

20. A method of processing meat to remove contaminates sourced from meat processing tools comprising:
processing meat using at least one meat processing tool as described in claim 1 to provide meat portions,
comminuting the meat portions;
heat-treating the comminuted meat at a temperature of at least about 120° C. for at least about 15 minutes to provide a heat-treated meat composition; and
conducting a metal detection screening to identify and segregate any metal present in the heat-treated meat composition;
wherein the heat-treated meat composition is substantially free of particulate matter derived from the dissolvable polymeric component.

21. The method of claim 20, wherein the meat portions are comminuted to provide comminuted meat having particles ranging in size from about 2 mm to 20 mm.

22. The method of claim 20, wherein the heat-treating step is performed at a temperature of at least 127° C. for a time of at least 45 min.

23. The method of claim 20, wherein the livestock animal is cattle.
